(19) United States
(12) Patent Application Publication
(10) Pub. No.: US 2026/0346191 A1
(43) Pub. Date: Nov. 5, 2026

(54) ANTI-MOISTURE DEVICE CONFIGURED TO BE ATTACHED TO A CLOSED HOUSING

(71) Applicant: AML SYSTEMS, Paris (FR)

(72) Inventors: Hassan KOULOUH, Lamorlaye (FR); Cyril RIVIER, Chatou (FR); Michel RINZLER, Paris (FR)

(21) Appl. No.: 19/538,862

(22) Filed: Feb. 12, 2026

(30) Foreign Application Priority Data
Feb. 12, 2025 (FR) FR2501435

(51) Int. Cl. B01D 53/26; B01D 53/04; B01D 53/22; F21S 45/50; G03B 17/08

(52) U.S. Cl. CPC B01D 53/261; B01D 53/0446; B01D 53/229; B01D 53/268; F21S 45/50; G03B 17/08; B01D 2257/80; B01D 2259/4566

(57) ABSTRACT

The anti-moisture device comprising at least one casing and a desiccant, the casing having a wall defining a chamber, the casing being attached to the closed housing so that a first part of the casing is within the enclosed space and a second part of the casing is outside the closed housing, the desiccant being contained within the chamber, the first part comprising a communication opening between the chamber and the enclosed space, the second part comprising an exhaust opening closed by a valve, the valve being configured to let the desiccant escape from the chamber through the exhaust opening when the desiccant exerts a pressure on the valve greater than or equal to a predetermined pressure.

### CROSS REFERENCE TO RELATED APPLICATIONS

This non-provisional patent application claims priority under 35 U.S.C. § 119 (a) from Patent Application No. FR2501435 filed in France on Feb. 12, 2025.

### FIELD OF THE INVENTION

The present disclosure relates to an anti-moisture device configured to be attached to a closed housing. The device is particularly suitable for use in removing moisture from a headlamp housing of a vehicle.

### BACKGROUND OF THE INVENTION

In many fields of activity, it is necessary to place items of equipment in closed housings for various reasons. For example, a closed housing may be used to protect a device from external threats. However, a closed housing is likely to encourage the appearance of moisture inside, particularly for outdoor applications, which may be detrimental to the device contained in the housing.

For example, a vehicle headlamp comprises a closed housing comprising a glass (or transparent plastic) and a light source within the closed housing. The closed housing is generally made of plastic. Moisture may diffuse through the plastic. The plastics of the housings of the headlamps absorb the surrounding moisture and diffuse it inside. This allows moisture to penetrate inside the housing of the headlamp. This moisture may be dangerous for the electrical components of the headlight. It may also condense on the lens or the glass of the headlamp. This condensation affects the illumination of the headlight, which may lead to a deterioration in its efficiency.

One solution is to use a device that removes moisture from the headlight. Such a device generally comprises a desiccant to adsorb moisture from the air. This desiccant, often contained in a sachet, is installed in the casing of the device. Absorption of moisture from the air by the desiccant results in an increase in the volume of said desiccant. The desiccant may reach a volume greater than the volume of the casing containing the desiccant, which may cause the casing to burst and the desiccant to spill into the housing of the headlight.

A similar problem may arise for camera devices, particularly for autonomous vehicles, which may be attached to the windscreen inside the passenger compartment to observe a scene in front of the vehicle. These camera devices are equipped with a housing inside which a camera or other vision instruments are installed. Because of the temperature differences between the inside of the passenger compartment and the outside, mist may form inside the housing, which may disrupt the operation of the vehicle in autonomous mode, or even render it inoperative.

### SUMMARY OF THE INVENTION

One objective of the present disclosure is to at least partially overcome the shortcomings of the prior art by providing an improved anti-moisture device.

According to the invention, the anti-moisture device comprises at least:
a casing having a wall defining a chamber, the casing being configured to be attached to the closed housing,
a desiccant contained in the chamber configured to adsorb moisture;
   a first part of the casing comprising a communication opening configured so that the chamber is in gaseous communication with the enclosed space when the anti-moisture device is attached to the closed housing, the communication opening being configured to allow moisture formed in the enclosed space to pass into the chamber so that the desiccant may become loaded with moisture,
   a second part of the casing comprising at least one exhaust opening closed by a valve, the valve being configured to let the desiccant loaded with moisture escape from the chamber through the exhaust opening when the desiccant loaded with moisture exerts on the valve a pressure greater than or equal to a predetermined pressure.

So, thanks to the valve, when the desiccant loaded with moisture reaches a predetermined volume in the chamber, the desiccant may escape through the valve, preventing the casing from bursting and allowing the desiccant to enter the closed housing.

The anti-moisture device may have one or more of the following characteristics, alone or in combination.

For example, the valve is an umbrella valve, the umbrella valve comprising a rod and a dome-shaped head having a base, the second part of the casing comprises a bore through the wall of the casing, the rod comprising a shoulder retaining the head against said at least one exhaust opening at the level of a base of the dome,

the head completely closing off said at least one exhaust opening as long as the pressure exerted on the head by the desiccant loaded with moisture is less than a predetermined pressure.

In addition, the anti-moisture device may comprise at least two, preferably four, exhaust openings, in particular in the form of an arc of a circle, the exhaust openings being arranged at least partially around the bore.

In addition, said at least one exhaust opening is arranged, for example, such that in the mounted state of the anti-moisture device, said at least one exhaust opening is located in a top part of the second part of the casing.

The anti-moisture device also comprises a pressure balancing channel isolated from the chamber between the outside of the closed housing and the enclosed space, the pressure balancing channel having a first orifice opening out to the outside of the closed housing and a second orifice configured to open out in the mounted state in the enclosed space of the closed housing.

By way of example, the ratio between the diameter and the length of the pressure balancing channel is less than or equal to 0.5, in particular less than or equal to 0.4 and more specifically less than or equal to 0.1 in order to prevent splashing water or external moisture from diffusing into the enclosed space.

Alternatively, the anti-moisture device may comprise a removable operculum configured to close off the communication opening when the anti-moisture device is not attached to the closed housing.

Advantageously, the anti-moisture device comprises in particular an attachment ring surrounding the casing between the first part of the casing and the second part of the casing, the anti-moisture device comprising an attachment interface configured to surround an embrasure of the closed housing, the attachment ring being configured to attach the anti-moisture device to the attachment interface.

In particular, the attachment ring and the attachment interface form a bayonet attachment system.

According to one embodiment, the first part of the casing and the second part of the casing each have a wall in the form of a straight cylinder closed at a first end and open at a second end, the first part and the second part being assembled together at their respective second ends, and

the second end of the cylinder of the second part of the casing comprises a cylindrical shoulder, the second end of the first part bearing against the cylindrical shoulder.

In addition, the attachment ring in particular extends the second part of the casing around the cylindrical shoulder surrounding the second end of the first part of the casing, and the anti-moisture device comprises a circular sealing gasket between the attachment ring and the second end of the first part of the casing, the sealing gasket being configured to provide a hermetic attachment between the anti-moisture device and the closed housing.

According to another optional aspect, the first orifice of the pressure balancing channel opens outside the closed housing through the cylindrical shoulder, the second orifice of the pressure balancing channel opening into a diffusion chamber in gaseous communication with the enclosed space of the closed housing, the diffusion chamber being a recess made in the first part of the casing, the pressure balancing channel extending between the first orifice and the second orifice in a thickness of the wall of the straight cylinder of the first part of the casing.

In addition, the diffusion chamber may be separated from the enclosed space by a first membrane configured to allow the passage of air between the diffusion chamber and the enclosed space and to prevent the passage of moisture from outside the closed housing towards the enclosed space.

In addition, the communication opening in the first part of the casing comprises, for example, a second membrane configured to allow the passage of moisture contained in the enclosed space towards the chamber.

The invention also relates to a vehicle headlamp comprising at least one closed housing accommodating a light source in the enclosed space.

According to the invention, said vehicle headlamp comprises an anti-moisture device as specified above, said anti-moisture device being attached in the embrasure of the closed housing so that the first part of the casing lies in the enclosed space and the second part of the casing lies outside the closed housing.

The invention also relates to an image pickup device comprising at least one closed housing accommodating a camera in the enclosed space.

According to the invention, said image pickup device comprises an anti-moisture device as specified above, said anti-moisture device being attached in the embrasure of the closed housing so that the first part of the casing is in the enclosed space and the second part of the casing is outside the closed housing.

### BRIEF DESCRIPTION OF THE DRAWINGS

The present disclosure, with its characteristics and advantages and given by way of example, will become clearer on reading the description given with reference to the appended drawings wherein:

FIG. 1 shows a perspective view of the anti-moisture device.

FIG. 2A shows a longitudinal sectional view of the anti-moisture device with a desiccant in new condition before being exposed to moisture.

FIG. 2B shows a longitudinal sectional view of the anti-moisture device with a desiccant loaded with moisture in gel form after exposure to moisture.

FIG. 3 shows an enlarged perspective view of the exhaust opening and the bore configured to receive the valve.

FIG. 4 shows an enlarged perspective view of the exhaust opening and of the valve.

FIG. 5 shows an enlarged perspective view of the exhaust opening and of the valve allowing the passage of the desiccant to escape from the chamber.

FIG. 6 shows a perspective view of the anti-moisture device equipped with a removable operculum closing off the communication opening.

FIG. 7 shows a perspective view of the anti-moisture device wherein the removable operculum has been removed from the communication opening.

FIG. 8 schematically represents a perspective view of a closed housing, in particular a vehicle headlight, to which an anti-moisture device has been attached.

FIG. 9 shows the anti-moisture device and an attachment interface configured to surround the embrasure of the closed housing to attach the anti-moisture device to the closed housing using the attachment ring.

### DETAILED DESCRIPTION

The achievements are examples. Although the description refers to one or more embodiments, this does not necessarily mean that each reference relates to the same embodiment. Simple characteristics of different embodiments may also be combined or interchanged to provide other embodiments, without departing from the scope of the invention as defined by the claims.

The following description is provided with reference to the above figures. In these figures, the identical elements have the same reference numbers.

In the description, the adjectives “top” and “low” are defined according to gravity. The adjective “low” describes the direction wherein an object is attracted by gravity, while the adjective “top” describes the opposite direction.

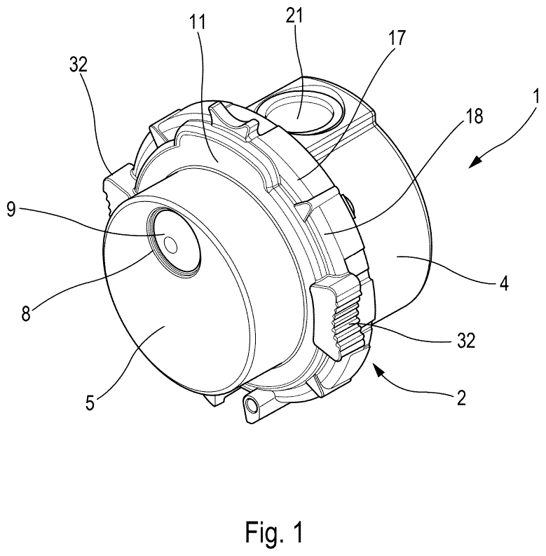

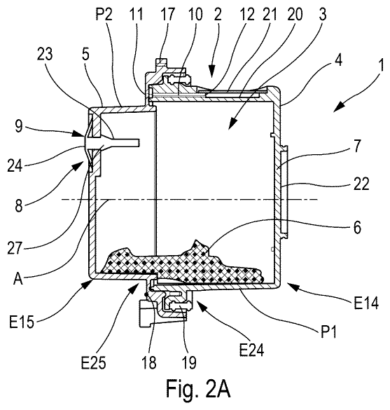

The invention relates to an anti-moisture device 1 configured to be attached to a closed housing 13 defining an enclosed space 14, as shown in FIGS. 1 and 2A. The anti-moisture device 1 is suitable for use in dehumidifying, i.e. removing moisture or preventing the appearance of moisture in any closed housing 13.

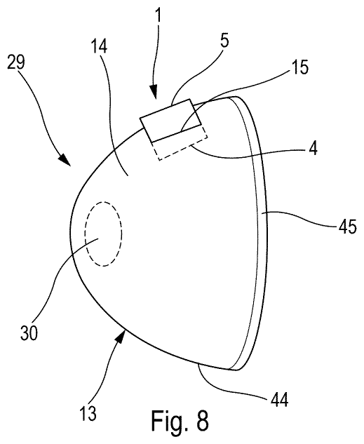

The anti-moisture device 1 is particularly suitable for implementing in a vehicle headlamp 29, as illustrated in a particular embodiment in FIG. 8.

In a similar way, without this being explicitly shown, the anti-moisture device 1 is in particular adapted to be implemented in an image pickup device comprising at least one closed housing accommodating a camera in the enclosed space or an optical detection sensor.

The anti-moisture device 1 comprises at least one casing 2 with a wall defining a chamber 3 and a desiccant 6 contained in the chamber 3.

The casing 2 is configured to be attached to the closed housing 13. The desiccant 6 is configured to adsorb moisture.

For example, the desiccant 6 is a mixture of magnesium chloride and carboxymethylcellulose (CMC) gelling powder.

As shown in FIG. 2A, the chamber 3 of the casing 2 contains the desiccant 6 in bulk, without it being contained in one or more sachets.

A first part 4 of the casing 2 comprising a communication opening 7 configured so that the chamber 3 is in gaseous communication with the enclosed space 14 when the anti-moisture device 1 is attached to the closed housing 13. The communication opening 7 is configured to allow the moisture formed in the enclosed space 14 to pass into the chamber 3 so that the desiccant 6 may be loaded with moisture.

In the description, the expression “when the anti-moisture device is attached to the closed housing” is equivalent to the expression “in the mounted state of the anti-moisture device”.

A second part 5 of the casing 2 comprises at least one exhaust opening 8 closed by a valve 9. The valve 9 is configured to let the desiccant 6 loaded with moisture to escape from the chamber 3 through the exhaust opening 8 when the desiccant 6 loaded with moisture exerts a pressure on the valve 9 greater than or equal to a predetermined pressure.

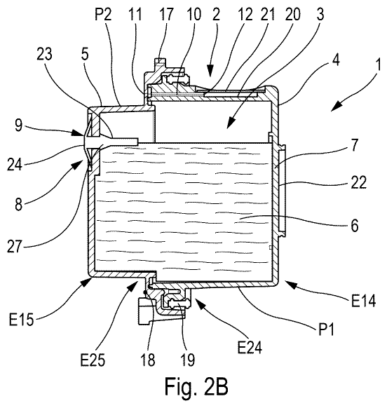

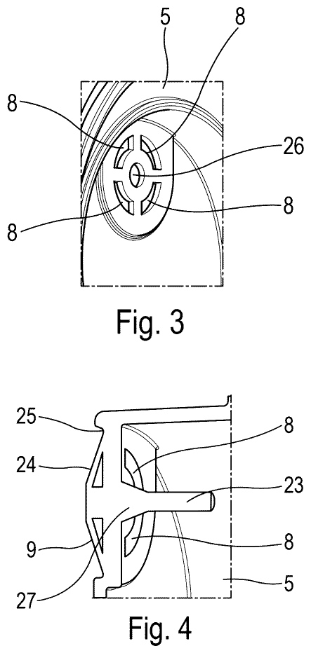

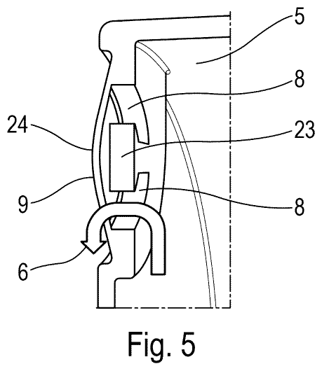

In an embodiment such as that shown in FIG. 1, FIG. 2A and FIG. 2B, the valve 9 corresponds to an umbrella valve. As illustrated in FIG. 2A, FIG. 2B and FIG. 4, the umbrella valve comprises a rod 23 and a dome-shaped head 24 with a base 25. As shown in FIG. 3, the second part 5 of the casing 2 comprises a bore 26 passing through the wall of the casing 2. The rod 23 comprises a shoulder 27 retaining the head 24 against said at least one exhaust opening 8 at the level of the base 25 of the dome, as shown in FIG. 4, FIG. 2A and FIG. 2B. The head 24 completely closes off said at least one exhaust opening 8 as long as the pressure exerted on the head 24 by the desiccant 6 loaded with moisture is less than the predetermined pressure. In addition, the head 24 deforms to allow the desiccant 6 loaded with moisture to escape from the chamber 3 through the exhaust opening 8 (FIG. 5) when the desiccant 6 loaded with moisture exerts a pressure on the head 24 greater than or equal to the predetermined pressure. The head may be made of silicone which is likely to deform when the pressure applied to said head is greater than or equal to the predetermined pressure.

As may be seen in FIG. 3, the anti-moisture device may comprise at least two, preferably four, exhaust openings 8. Each of the exhaust openings 8 may be arranged in the shape of an arc of a circle. The exhaust openings 8 may be arranged, at least partially, around the bore 26 (FIG. 3).

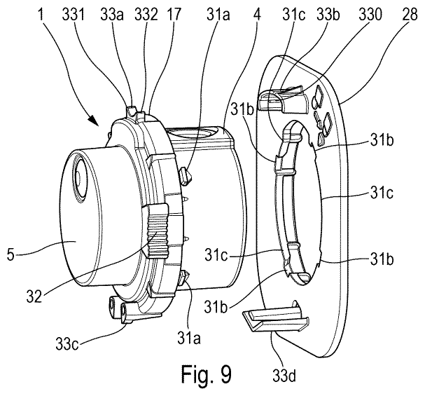

In a preferred embodiment, said at least one exhaust opening 8 is arranged such that, in the mounted state of the anti-moisture device 1, said at least one exhaust opening 8 is located in a top part of the second part 5 of the casing 2, as shown in FIG. 1, FIG. 2A, FIG. 2B and FIG. 9. The top part is in particular the one which is above the axis A (see FIG. 2A) which is the axis passing through the anti-moisture device 1 and centered in relation to the communication opening 7.

In this embodiment of FIG. 2A, the desiccant 6 is not yet loaded with moisture and is located in a low part of the chamber 3. The filling level of the desiccant 6 is therefore at the low part of the chamber 3. It is therefore not level with the at least one exhaust opening 8. As the desiccant 6 is loaded with moisture, it takes up more and more space in the chamber 3. The fill level then rises towards the top part of the chamber 3 until it reaches the at least one exhaust opening 8, as shown in FIG. 2B. As soon as the desiccant 6 reaches the at least one exhaust opening 8 (FIG. 2B), it may exert a pressure against the valve 9. When the desiccant 6 loaded with moisture exerts a pressure on the valve 9 greater than or equal to the predetermined pressure, the valve 9 allows the desiccant 6 to escape from the chamber 3 through the at least one exhaust opening 8.

By way of a non-limiting example, the height of the at least one exhaust opening 8 and the predetermined pressure are chosen so that the volume of desiccant 6 loaded with moisture reaches 90% of the volume of the chamber 3.

Advantageously, the anti-moisture device 1 comprises a pressure balancing channel 10 isolated from the chamber 3 between the outside of the closed housing 13 and the enclosed space 14. The pressure balancing channel 10 has a first orifice 11 opening outside the closed housing 13 and a second orifice 12 configured to open into the enclosed space 14 of the closed housing 13 when the anti-moisture device 1 is mounted. The pressure balancing channel 10 allows air to circulate between the outside of the closed housing 13 and the enclosed space 14. Isolating the pressure balancing channel 10 from the chamber 3 prevents any moisture that may be contained in the air (which equalizes the pressure between the outside of the closed housing 13 and the enclosed space 14) passing through the pressure balancing channel 10 from being absorbed by the desiccant 6, thereby increasing the operating time of the desiccant 6.

The pressure balancing channel 10 has a diameter (of the cross-section of said channel) and a length which depends on the following equation which follows from Fick's laws at constant temperature:

$$F = D \frac{π}{4} \frac{{d}^{2}}{l} ( {P}_{ext} - {P}_{i n t} )$$

wherein:
F is the flow of moisture (water vapor) circulating in the pressure balancing channel 10,
D corresponds to the diffusion coefficient (in m³/s) of moisture in the air,
d corresponds to the diameter (in mm) of the pressure balancing channel 10,
l is the length (in mm) of the pressure balancing channel 10,
Pₑₓₜ corresponds to the partial pressure (in kPa) of the moisture outside the closed housing 13,
Pᵢₙₜ corresponds to the partial pressure (in kPa) of the moisture in the chamber 3.

The diameter d and the length l are therefore determined to minimize the flow of moisture F.

In a non-limiting manner, the ratio between the diameter and the length of the pressure balancing channel 10 is less than or equal to 0.5, in particular less than or equal to 0.4 and more specifically less than or equal to 0.1 in order to prevent water splashes or external moisture by diffusion from entering the enclosed space 14.

As a non-limiting example, the diameter of the pressure balancing channel 10 is 1 mm (at least 0.8 mm) and its length is 15 mm (at least 2 mm).

In this way, this pressure balancing channel 10 allows a sufficiently large exchange of air to balance the pressures, but is sufficiently small that it is not a source of significant diffusion of external moisture towards the inside of the closed casing 13.

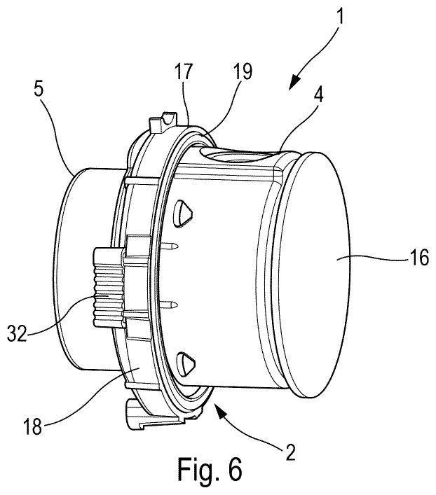

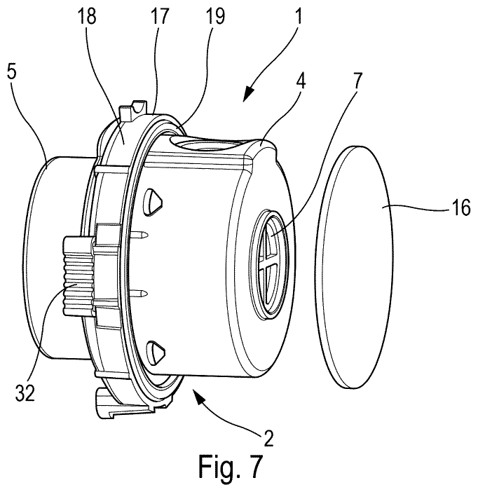

According to an embodiment shown in FIG. 6 and FIG. 7, the anti-moisture device 1 comprises a removable operculum 16 configured to hermetically close off the communication opening 7 when the anti-moisture device 1 is not attached to the closed housing 13. This removable operculum 16 prevents the desiccant from absorbing moisture before it is attached to the closed housing 13. Typically, the anti-moisture devices are enclosed in a waterproof bag when not attached to the closed housing 13 to prevent the desiccant from absorbing moisture. The use of a removable operculum 16 eliminates the need for plastic bags. In addition, the removable operculum 16 may be reused for other anti-moisture devices 1. For example, to fit a headlamp, the removable operculum 16 is removed and may then be returned to the manufacturer for reuse.

In one embodiment, the device comprises an attachment ring 17 surrounding the casing 2 between the first part 4 of the casing 2 and the second part 5 of the casing 2. The anti-moisture device 1 comprises an attachment interface 28 (see FIG. 9) configured to surround an embrasure 15 in the closed housing 13. The attachment ring 17 is thus configured to attach the anti-moisture device 1 to the attachment interface 28.

By way of a non-limiting example, the attachment ring 17 and the attachment interface 28 form a bayonet attachment system. In FIG. 9, the second part 5 of the casing 2 comprises lugs 31a configured to engage in notches 31b. By rotating the casing 2 about its longitudinal axis A, the lugs 31a are held by portions 31c of the attachment interface 28. To facilitate rotation of the casing, the anti-moisture device 1 may comprise gripping elements 32 allowing the casing to be held and rotated about the longitudinal axis after the lugs 31a have passed through the notches 31b. The gripping elements 32 may be arranged on the attachment ring 17.

In addition, the anti-moisture device 1 may comprise locking elements 33a, 33b, 33c, 33d. The locking elements 33a, 33b, 33c, 33d are configured to prevent unintentional rotation of the casing 2 when the casing 2 is attached to the attachment interface 28. For example, the attachment ring 17 may comprise first locking elements 33a, 33c which are configured to engage with second locking elements 33b, 33d when the lugs 31a are held by the portions 31c of the attachment interface 28.

As shown in FIG. 9, the locking element 33b comprises a safety lug 330 which projects perpendicularly from the attachment interface 28. The locking element 33a which is configured to engage with the locking element 33b comprises a protuberance shaped like cat ears 331, 332 which project radially from the attachment ring 17. When the lugs 31a are engaged in the notches 31b, the safety lug 330 is located on the protuberance between the two cat ears 331, 332. When the casing 2 rotates, the safety lug 330 moves up onto the cat ear 331 so that it is no longer located on the protuberance. If someone tries to remove the casing 2 by turning it, the safety lug 330 breaks against the cat ear 331. So, if the safety lug 330 is broken, you may be sure that the casing 2 has been removed from the attachment interface 28 at least once.

The locking elements 33c and 33d prevent the casing 2 from rotating when it is mounted on the attachment interface 28.

In one embodiment, the first part 4 of the casing 2 and the second part 5 of the casing 2 each have a wall in the form of a straight cylinder P1, P2 closed at a first end E14, E15 and open at a second end E24, E25 (FIG. 2A and FIG. 2B). The first part 4 and the second part 5 are assembled together at their respective second ends E24, E25. In addition, the second end E25 of the cylinder of the second part 5 of the casing 2 may comprise a cylindrical shoulder 18. The second end E24 of the first part 4 rests against the cylindrical shoulder 18. The longitudinal axis A may correspond to the axis of revolution of the straight cylindrical walls P1, P2.

In one embodiment, the attachment ring 17 extends the second part 5 of the casing 2 around the cylindrical shoulder 18, surrounding the second end E24 of the first part 4 of the casing 2. Advantageously, the anti-moisture device 1 comprises a circular sealing gasket 19 between the attachment ring 17 and the second end E24 of the first part 4 of the casing 2. The sealing gasket 19 is configured to provide a hermetic attachment between the anti-moisture device 1 and the closed housing 13.

According to an embodiment, the first orifice 11 of the pressure balancing channel 10 opens to the outside of the closed housing 13 through the cylindrical shoulder 18. The second orifice 12 of the pressure balancing channel 10 opens into a diffusion chamber 20 in gaseous communication with the enclosed space 14 of the closed housing 13. The diffusion chamber 20 may be a recess in the first part 4 of the casing 2. In FIG. 2A and FIG. 2B, the diffusion chamber 20 corresponds to a recess in the straight cylindrical wall P1 of the first part 4 of the casing 2. Advantageously, the pressure balancing channel 10 extends between the first orifice 11 and the second orifice 12 in a wall thickness of the straight cylinder P1 of the first part 4 of the casing 2.

The diffusion chamber 20 may be separated from the enclosed space 14 by a first membrane 21 configured to allow the passage of air between the diffusion chamber 20 and the enclosed space 14 and to prevent the passage of moisture from outside the closed housing 13 into the enclosed space 14.

For example, the first membrane 21 is made of non-woven polyethylene fibers.

Similarly, the communication opening 7 in the first part 4 of the casing 2 may comprise a second membrane 22 configured to allow the passage of the moisture contained in the enclosed space 14 towards the chamber 3 and to prevent the desiccant loaded with moisture and transformed into a gel from spilling into the enclosed space 14.

As a non-limiting example, the second membrane 22 is made of woven polyvinyl chloride.

The invention also relates to a vehicle headlamp 29 comprising at least one closed housing 13 accommodating a light source 30 in the enclosed space 14 (FIG. 8). For example, the closed housing 13 may comprise a wall 44 and a window 45 configured to face the outside of the vehicle. The vehicle headlamp 29 comprises the anti-moisture device 1 described above. Said anti-moisture device 1 is attached in the embrasure 15 of the closed housing 13 so that the first part 4 of the casing 2 is in the enclosed space 14 and the second part 5 of the casing 2 is outside the closed housing 13.

1. An anti-moisture device configured to be attached to a closed housing defining an enclosed space,
characterized in that it comprises at least:
a casing having a wall defining a chamber, the casing being configured to be attached to the closed housing,
a desiccant contained in the chamber configured to adsorb moisture;
a first part of the casing comprising a communication opening configured so that the chamber is in gaseous communication with the enclosed space when the anti-moisture device is attached to the closed housing, the communication opening being configured to allow moisture formed in the enclosed space to pass into the chamber so that the desiccant may be loaded with moisture,
a second part of the casing comprising at least one exhaust opening closed by a valve, the valve being configured to let the desiccant loaded with moisture escape from the chamber through the exhaust opening when the desiccant loaded with moisture exerts on the valve a pressure greater than or equal to a predetermined pressure.

2. The device according to claim 1,
characterized in that the valve corresponds to an umbrella valve, the umbrella valve comprising a rod and a dome-shaped head having a base, the second part of the casing comprises a bore passing through the wall of the casing, the rod comprising a shoulder retaining the head against said at least one exhaust opening at the level of a base of the dome, the head completely closing off said at least one exhaust opening as long as the pressure exerted on the head by the desiccant loaded with moisture is less than a predetermined pressure.

3. The device according to claim 2,
characterized in that it comprises at least two, preferably four, exhaust openings, in particular in the form of an arc of a circle, the exhaust openings being arranged at least partially around the bore.

4. The device according to claim 1,
characterized in that said at least one exhaust opening is arranged such that, in the mounted state of the anti-moisture device, said at least one exhaust opening is located in a top part of the second part of the casing.

5. The device according to claim 4,
characterized in that it comprises a pressure balancing channel isolated from the chamber between the outside of the closed housing and the enclosed space, the pressure balancing channel having a first orifice opening out on the outside of the closed housing and a second orifice configured to open out in the mounted state in the enclosed space of the closed housing.

6. The device according to claim 5,
characterized in that the ratio between the diameter and the length of the pressure balancing channel is less than or equal to 0.5 in order to prevent splashing water or external moisture from diffusing into the enclosed space.

7. The device according to claim 1,
characterized in that it comprises an attachment ring surrounding the casing between the first part of the casing and the second part of the casing, the anti-moisture device comprising an attachment interface configured to surround an embrasure of the closed housing, the attachment ring being configured to attach the anti-moisture device to the attachment interface.

8. The device according to claim 1,
characterized in that the first part of the casing and the second part of the casing each have a wall in the form of a straight cylinder closed at a first end and open at a second end, the first part and the second part being assembled together at their respective second ends and in that the second end of the cylinder of the second part of the casing comprises a cylindrical shoulder, the second end of the first part bearing against the cylindrical shoulder.

9. The device according to claim 8,
characterized in that the attachment ring extends the second part of the casing around the cylindrical shoulder, surrounding the second end of the first part of the casing,
and in that it comprises a circular sealing gasket between the attachment ring and the second end of the first part of the casing, the sealing gasket being configured to provide a hermetic attachment between the anti-moisture device and the closed housing.

10. The device according to claim 5,
characterized in that the first orifice of the pressure balancing channel opens outside the closed housing through the cylindrical shoulder, the second orifice of the pressure balancing channel opening into a diffusion chamber in gaseous communication with the enclosed space of the closed housing, the diffusion chamber being a recess made on the first part of the casing, the pressure balancing channel extending between the first orifice and the second orifice in a thickness of the wall of the straight cylinder of the first part of the casing.

11. The device according to claim 10,
characterized in that the diffusion chamber is separated from the enclosed space by a first membrane configured to allow the passage of air between the diffusion chamber and the enclosed space and to prevent the passage of moisture from outside the closed housing towards the enclosed space.

12. The device according to one of claim 11,
characterized in that the communication opening of the first part of the casing comprises a second membrane configured to allow the passage of moisture contained in the enclosed space towards the chamber.

13. A vehicle headlamp comprising at least one closed housing accommodating a light source in the enclosed space,
characterized in that said vehicle headlamp comprises an anti-moisture device according to any one of claim 1, said anti-moisture device being attached in the embrasure of the closed housing so that the first part of the casing lies in the enclosed space and the second part of the casing lies outside the closed housing.

14. An image pickup device comprising at least one closed housing accommodating a camera in the enclosed space,
characterized in that said image pickup device comprises an anti-moisture device according to any one of claim 1, said anti-moisture device being attached in the embrasure of the closed housing so that the first part of the casing is in the enclosed space and the second part of the casing is outside the closed housing.

15. The device according to claim 2,
characterized in that said at least one exhaust opening is arranged such that, in the mounted state of the anti-moisture device, said at least one exhaust opening is located in a top part of the second part of the casing.

16. The device according to claim 3,
characterized in that said at least one exhaust opening is arranged such that, in the mounted state of the anti-moisture device, said at least one exhaust opening is located in a top part of the second part of the casing.

17. The device according to claim 2,
characterized in that it comprises an attachment ring surrounding the casing between the first part of the casing and the second part of the casing, the anti-moisture device comprising an attachment interface configured to surround an embrasure of the closed housing, the attachment ring being configured to attach the anti-moisture device to the attachment interface.

18. The device according to claim 3,
characterized in that it comprises an attachment ring surrounding the casing between the first part of the casing and the second part of the casing, the anti-moisture device comprising an attachment interface configured to surround an embrasure of the closed housing, the attachment ring being configured to attach the anti-moisture device to the attachment interface.

19. The device according to claim 2,
characterized in that the first part of the casing and the second part of the casing each have a wall in the form of a straight cylinder closed at a first end and open at a second end, the first part and the second part being assembled together at their respective second ends and in that the second end of the cylinder of the second part of the casing comprises a cylindrical shoulder, the second end of the first part bearing against the cylindrical shoulder.

20. The device according to claim 3,
characterized in that the first part of the casing and the second part of the casing each have a wall in the form of a straight cylinder closed at a first end and open at a second end, the first part and the second part being assembled together at their respective second ends and in that the second end of the cylinder of the second part of the casing comprises a cylindrical shoulder, the second end of the first part bearing against the cylindrical shoulder.
